(19) United States
(12) Patent Application Publication
(10) Pub. No.: US 2025/0111246 A1
(43) Pub. Date: Apr. 3, 2025

(54) CONTEXT-BASED WORKFLOW PROCESSING

(71) Applicant: ServiceNow, Inc., Santa Clara, CA (US)

(72) Inventor: Philip Casini, Salem, OR (US)

(21) Appl. No.: 18/889,795

(22) Filed: Sep. 19, 2024

Related U.S. Application Data
(60) Provisional application No. 63/542,026, filed on Oct. 2, 2023.

(51) Int. Cl. G06N 5/02; G06N 5/04

(52) U.S. Cl. CPC G06N 5/02; G06N 5/04

(57) ABSTRACT

Data from a plurality of data sources is received. A knowledge graph is generated using the received data to discover user relationships between elements of the data from the plurality of data sources. A query associated with a workflow is received from a user. Using an application programming interface, the knowledge graph is queried for data associated with the user and the query. A recommendation associated with the workflow is determined by analyzing a result of the query of the knowledge graph.

### CROSS REFERENCE TO OTHER APPLICATIONS

This application claims priority to U.S. Provisional Patent Application No. 63/542,026 entitled KNOWLEDGE GRAPH AND DECISION INTELLIGENCE filed Oct. 2, 2023, which is incorporated herein by reference for all purposes.

### BACKGROUND OF THE INVENTION

Web applications and services allow organizations to automate complex business processes. For example, a chat interface can allow an employee to interface with an employer chat agent to handle employee issues such as requesting a new laptop, answering questions related to human resource policies, or resolving information technology (IT) incidents. These business processes can be implemented as digital workflows that are initiated in response to a query. However, these workflows typically require a user (such as the employee) to provide contextual information for accurate processing of the query. This data gathering process can be tedious, error-prone, and redundant, and in many scenarios, often leads to introducing contextual errors to the workflow. Therefore, there exists a need for a workflow system that can incorporate and apply accurate contextual information with minimal generated user friction.

### BRIEF DESCRIPTION OF THE DRAWINGS

Various embodiments of the invention are disclosed in the following detailed description and the accompanying drawings.

FIG. 1 is a block diagram illustrating an embodiment of a context-based workflow processing system.

FIG. 2 is a block diagram illustrating an embodiment of a knowledge graph module for performing context-based digital workflows.

FIG. 3 is a block diagram illustrating an embodiment of a knowledge graph module for performing context-based digital workflows.

FIG. 4 is a block diagram illustrating an embodiment of a workflow service for performing context-based digital workflows.

FIG. 5 is a flow chart illustrating an embodiment of a process for performing a context-based workflow processing.

FIG. 6 is a flow chart illustrating an embodiment of a process for providing a knowledge graph service or performing context-based workflow processing.

FIG. 7 is a flow chart illustrating an embodiment of a process for resolving a user query using context-based data and a digital workflow.

FIG. 8 is a diagram illustrating an embodiment of a user interface displaying the results of performing a context-based digital workflow.

FIG. 9 is a functional diagram illustrating a programmed computer system for performing context-based digital workflows.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Context-based digital workflow processing is disclosed. For example, using the disclosed techniques and systems, a digital workflow processing system can be implemented that utilizes contextual information when performing digital workflows for query resolution. For example, when a query is received, such as via a chat agent, the query is analyzed and one or more appropriate digital workflows are performed. The workflows generate a recommendation in response to the query and can include performing interactive and actionable activities, such as initiating the purchase of a new laptop, automatically patching a software to the latest version, or providing a pre-completed human resources form. In various embodiments, the workflow process is augmented with contextual information including information retrieved from a knowledge graph and/or historical and/or supplemental data. The augmentation of the query resolution with relevant contextual data allows the initial query to be resolved significantly more efficiently and effectively including by identifying related issues for resolution and reducing redundant and error-prone data gathering steps.

In some embodiments, the digital workflow processing utilizes a knowledge graph to obtain relevant context information. For example, a knowledge graph or similar interactive data store can be accessed to retrieve associated data sourced from multiple different data sources. The knowledge graph data initially retrieves data from multiple different data sources, such as a geo-location data store, a company data store, an organization data store, a chat history data store, a related incident history data store, an information technology (IT) data store, and third-party data stores, etc. Data from the different data sources is aggregated and analyzed to identify data relationships and associations, such as all data related to a user or employee. For example, in some embodiments, the knowledge graph is organized based on user information, merging user related information such as a user's assigned office location, role and place in an organization, chat and incident history, allocated and assigned IT resources such as computing hardware and software, declared elections for different human resource plans such as health insurance, life insurance, and retirement accounts, etc. into a user profile applicable for resolving user-related queries.

In some embodiments, historical or supplemental data can be similarly retrieved for a query to augment the context and provide further insight for efficiently and effectively resolving the query. The historical/supplemental data may be associated with other incidents related to the query, such as events and associated resolutions experienced by other related users. For example, supplemental data can include the appropriate resolution used to resolve the same incident experienced by other users. In some embodiments, the historical/supplemental data for incidents and their resolutions can be segmented, for example, by limiting the related data to users in the same geography, with the same or similar IT configuration, within a certain time window, etc.

In various embodiments, by augmenting the query context with retrieved knowledge graph and historical/supplemental data, the query is analyzed with the proper contextual data needed to determine an intent of the query. Based on the determined intent, one or more corresponding digital workflows are performed. The performed workflows can be interactive workflows and are designed to result in a recommended resolution for the query. In some embodiments, the resolution can include multiple actionable events and each of the resolution events are performed. For example, in response to a query related to a laptop hardware problem initiated via a chat agent, the workflow system can retrieve information for the query including knowledge graph and historical/supplemental data to determine and implement multiple resolution outcomes including proactive recommended actions based on the retrieved contextual information. The system can identify and implement proactive resolution outcomes based on determining, for example, that the user's account requires an updated password and that the user is qualified for a new laptop. Although the outcomes are not strictly dependent on one another, both outcome recommendations are identified and flow from the same single query based on the retrieved contextual user information. Thus, instead of requiring multiple queries across multiple distinct interactive chat sessions, each chat session with its own tedious data gathering process, the user can have all related recommendation outcomes resolved from a single initiated query. Using the disclosed context-based workflow process, user queries can utilize an expanded context of a user's experience and thereby initiate multiple non-dependent recommendation outcomes, such as actionable events to assist the user in both updating their password and prompting them on whether they'd like to order a new laptop.

In various embodiments, the multiple recommendation outcomes can correspond to multiple workflows or sub-workflows initiated from a parent workflow. Moreover, each workflow can include multiple steps including interactive, non-interactive, and out-of-band steps. For example, as part of a workflow process with multiple outcomes, a user's password can be updated, the user's manager can be alerted for approval of a new laptop, and any out-of-date software on the existing laptop can be updated for both the existing and new laptop. By providing the augmented context data to respond to a query, the provided context-based information allows the query to be addressed in a more complete manner including by identifying, predicting, and/or anticipating additional issues and addressing these issues with a corresponding workflow. For example, the knowledge graph data for a user provides contact information for the user's manager, a user office location and address to ship the new laptop, a list of software and versions of the software installed for the user, and the status of the user's password. In traditional systems, each action or outcome would require multiple back-and-forth interactions in order to gather the information required to implement even a single of the recommended actions. Moreover, many of the actions would require gathering the same information, resulting in multiple duplicative and tedious interactions. As these actions and interactions increase, errors are commonly introduced into the workflow resulting in corrupted or flawed workflow results. By integrating contextual information into the workflow process, the data gathering process is significantly more efficient, and the likelihood that errors are introduced is greatly minimized at least in part by removing multiple data dependencies from the user to a centralized knowledge graph and related server-side data stores. Moreover, in the disclosed embodiments, the workflow service can be configured to only request information from a user that the workflow process cannot retrieve on its own, further improving the user experience.

As set forth, a context-based digital workflow process allows for the processing of digital workflows with minimal user intervention including with minimal user data gathering steps. Typically, data gathering steps are interactive, time-consuming, and error prone. For example, a user can be prompted for data which can create data conflicts when the provided data differs with similar data that already exists but is available from another data source. Moreover, the traditional approach is frustrating to users since users are often asked to provide data that already exists but is inaccessible in the current context due to technical incompatibilities or inaccessibility between data source systems. Without the context-based information provided by the disclosed invention, the data required for resolving user queries is incomplete. By generating a knowledge graph based on entities, their relationships, and their properties, knowledge graph data, such as a knowledge graph for a user, can be used to augment a user query. With the disclosed invention, the user query is augmented with a more complex and complete context that allows the analysis of the user query to identify previously undetectable issues. Instead, with the provided additional context, the analysis of the user query can be expanded beyond the initial and very limited initial state. In this manner, the analysis can anticipate issues undetectable without the augmented context-based workflow data.

In consideration of these and other technical challenges, the disclosed solutions provide an efficient and effective framework for performing digital workflows using an expanded workflow context. The ability to access data organized by an entity and its relationships when processing a query significantly increases the correctness of the query resolution and the completeness of the recommended solutions. Moreover, the augmented data provides technical access to relevant context previously unavailable at the time of analysis. The contextual data may be unavailable due to requiring a tedious user-centric process for gathering the data and/or the data may be dispersed across multiple incompatible and unrelated data sources. As the number of disperse data sources increases, the challenges in unifying the data sources and the failure to identify query resolutions due to an incomplete context increase dramatically. The disclosed techniques and systems provide an efficient and effective solution for resolving user queries with digital workflows by providing the appropriate context data while also minimizing the expected burden on the user.

In some embodiments, data from a plurality of data sources is received. For example, multiple internal and external data sources can be configured for a knowledge graph module. Example data sources include a geo-location data store, a company data store, an organization data store, a chat history data store, a related incident history data store, an information technology (IT) data store, and third-party data stores such as employee payroll data stores and health care plan data stores. In some embodiments, a knowledge graph is generated using the received data to discover user relationships between elements of the data from the plurality of data sources. For example, data relationships and associations are identified from the data retrieved via the configured data sources. The relationships and associations can be centered on common dependencies such as based on a user or employee. For example, a knowledge graph can be constructed based on user profiles merging user related information such as a user's assigned office location, role and place in an organization, chat and incident history, allocated and assigned IT resources such as computing hardware and software, declared elections for different human resource plans such as health insurance, life insurance, and retirement accounts, etc. into a user profile applicable for resolving user-related queries. By identifying relationships and associations in information spread across multiple different data sources, the related information for a particular data entity can be centralized. By centralizing the related data, application solutions can be implemented that address issues not identifiable without the additional identified relationship context.

In some embodiments, a query associated with a workflow is received from a user. For example, a user or employee can provide a query in the format of a chat message to a chat agent. The chat message is translated into a user query and associated with a workflow for resolving the query. In some embodiments, identifying the workflow includes determining an initial intent for the query. For example, a query can be initiated from the received chat message “My laptop is slow” and a corresponding intent can be determined using a workflow process. In some embodiments, an initial intent is refined using additional context-based information. In some embodiments, using an application programming interface (API), the knowledge graph is queried for data associated with the user and the query. For example, a knowledge graph module can be accessed via an API to retrieve context-based information related to the user and the query. The context-based information from the knowledge graph module can include data sourced from multiple different databases but gathered together arranged within a knowledge graph based on identified data relationships and associations. Without the unified retrieval access provided by the API, the information of the knowledge graph is inaccessible in a practical and timely manner. The API provides a highly efficient approach to retrieving context-based data critical for fully resolving the query.

In some embodiments, a recommendation associated with the workflow is determined by analyzing a result of the query of the knowledge graph. For example, the query is analyzed with the retrieved context-based information to determine a recommendation resolution. The determined recommendation can include multiple outcomes including initiating interactive workflows such as for changing an employee's home address or automated and out-of-band workflows such as for migrating a user's software to a new version when the user is no longer logged into the laptop. The augmented data retrieved from the knowledge graph allows for a more complete analysis and the ability to identify user query intents and corresponding workflow resolutions not identifiable without the additional context. Moreover, the augmented data allows for the automation of workflows that ordinarily would require multiple tedious and interactive data gathering steps. These avoided data gathering steps are prone to user error and can commonly result in a failed or misidentified user query resolution due to the introduction of faulty user data and additional delay. By analyzing the query with the additional knowledge graph data, the resulting resolutions to the user query can be performed quickly and efficiently with minimal required user oversight.

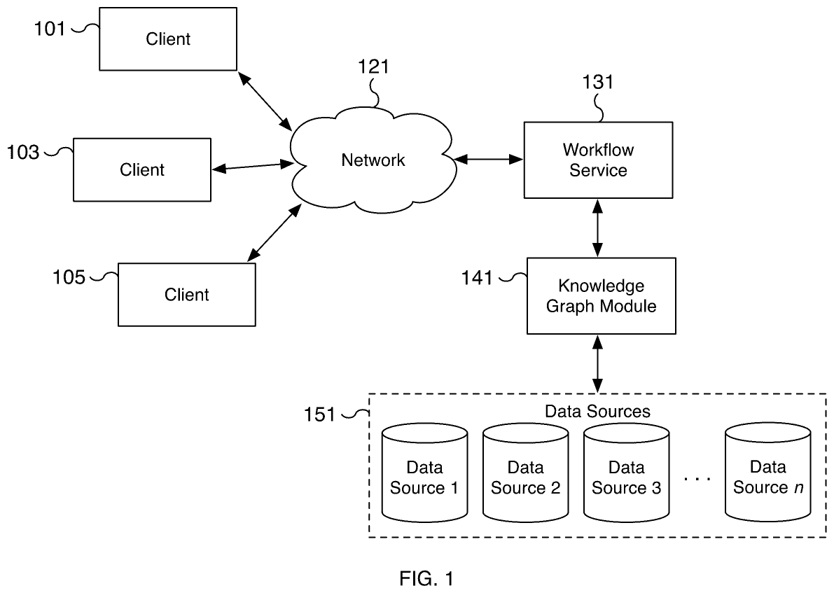

FIG. 1 is a block diagram illustrating an embodiment of a context-based workflow processing system. In the example shown, clients 101, 103, and 105 are network clients configured to access workflow service 131 to resolve client user queries. Clients 101, 103, and 105 are communicatively connected to workflow service 131 via network 121. Network 121 can be a public or private network. In some embodiments, network 121 is a public network such as the Internet. Workflow service 131 provides web application services that are implemented using one or more digital workflows to address user queries from clients 101, 103, and/or 105. For example, from within a client browser of clients 101, 103, or 105, a user can interactively submit queries such as via a chat agent using workflow service 131. Workflow service 131 resolves the user query by analyzing the query using relevant context-based data retrieved from knowledge graph module 141. Knowledge graph module 141 organizes related and associated data from data sources 151, which is made up of multiple different data sources.

In some embodiments, clients 101, 103, and 105 are each a network client device for interfacing with digital workflows hosted by workflow service 131. For example, each of clients 101, 103, and 105 can be configured with a client, such as a web browser, to access workflows hosted by workflow service 131. For example, clients 101, 103, and 105 can utilize a client-side version of a chat system to message a server-side version of the chat system of workflow service 131. As another example, clients 101, 103, and 105 can utilize a client-side version or interface (such as via a web browser) to interface with a web application interface such as a web application dashboard or online intake system of workflow service 131. In various embodiments, clients 101, 103, and 105 can provide a user query to workflow service 131 via different mechanisms such as via a chat message, a chat dialogue, a user selected action, etc. In some embodiments, the users of clients 101, 103, and 105 can correspond to a particular configured group of users, such as employees for an organization.

In some embodiments, workflow service 131 corresponds to one or more cloud servers that offer functionality for managing user queries via digital workflows. The digital workflows can be configured using a workflow designer application to create workflows for automating complex business processes. In various embodiments, a workflow process can be interactive or non-interactive, and may be performed synchronously, in real-time, and/or asynchronously. In various embodiments, workflow service 131 resolves a user query by determining an intent for the query and mapping the intent to one or more digital workflows or sub-workflows. The determined workflows are then processed to resolve the user query. In some embodiments, the workflow determines one or more recommendations or recommended outcomes. For example, in response to a query based on a user reported slow laptop, as part of a workflow process with multiple outcomes, a user's password can be updated, the user's manager can be alerted for approval for issuing the user a new laptop, and any out-of-date software on a user's existing laptop can be updated for both the user's existing and new laptop.

In some embodiments, workflow service 131 utilizes contextual information including information retrieved from knowledge graph module 141 and/or supplemental and/or historical information. For example, relevant information on the user can be retrieved from knowledge graph module 141 and used to resolve the user query. Similarly, workflow service 131 can include access to supplemental and/or historical information for resolving the user query. For example, supplemental and/or historical information can include relevant information for resolving the query that is not found in the knowledge graph for the specific user. Examples of supplemental or historical information can include recently applied incident solutions for similar issues that have impacted other users. In some embodiments, workflow service 131 includes one or more data stores (not shown) for supplemental and/or historical information. In some embodiments, the historical information is a subset of the supplemental information.

In some embodiments, workflow service 131 can implement one or more different techniques for intaking a user query. For example, workflow service 131 can implement a chat agent or other intake service to capture user queries. In some embodiments, the chat messages may be used to generate a user query in a particular technical format and the user query can include additional information such as a user identifier. Once a user query is received at workflow service 131, workflow service 131 can resolve the user query using a digital workflow matching the determined intent of the user query. In some embodiments, the intent can be determined based on the retrieved contextual information. The intent determination may be a multi-step process that refines the intent as additional contextual information is received. In various embodiments, an intent can include multiple sub-intents and/or a user query can be mapped to multiple intents, each with the potential for executing a different workflow. In some embodiments, workflow service 131 is accessible via an application programming interface (API), for example, for providing a user query for resolution.

In some embodiments, knowledge graph module 141 is a knowledge graph service that allows for the retrieval of information organized using a knowledge graph. For example, knowledge graph module 141 can organize associated and related data to construct a knowledge graph organized by users. When accessed, such as via an application programming interface (API) by workflow service 131, knowledge graph module 141 can return user data such as all data associated with a user that knowledge graph module 141 can access. In the example shown, knowledge graph module 141 is configured to access data stores 151 which include data source 1 through data source n. The data sources can correspond to different stores of data and may be organized by application, category, service, etc. Knowledge graph module 141 can retrieve the data from data stores 151 and organize related and associated data as a knowledge graph. For example, data for a user from different sources of data stores 151 can be organized into a knowledge graph such as by merging a user's assigned office location, role and place in an organization, chat and incident history, allocated and assigned IT resources such as computing hardware and software, declared elections for different human resource plans such as health insurance, life insurance, and retirement accounts, and other accessible related user information into a user profile accessible via knowledge graph module 141.

In some embodiments, data stores 151 are a collection of different data stores used by knowledge graph module 141. The data stores can include internal and external data stores. For example, internal data stores may be hosted by the same organization that hosts workflow service 131, whereas external data stores can be hosted by a third-party and may be accessed via a third-party application programming interface (API). In some embodiments, the third-party data stores may exist on a different network (such as a different corporate network infrastructure) and may be accessible via a non-local network such as network 121. In the example of FIG. 1, the multiple datastores are shown as data source 1 through data source n. Example data sources can include a geo-location data store, a company data store, an organization data store, a chat history data store, a related incident history data store, an information technology (IT) data store, and third-party data stores.

Although single instances of some components have been shown to simplify the diagram of FIG. 1, additional instances of any of the components shown in FIG. 1 may exist. For example, workflow service 131 may be implemented by one or more workflow servers and knowledge graph module 141 may be similarly implemented by one or more knowledge graph servers. Additionally, clients 101, 103, and 105 are example client devices for accessing and utilizing the services of workflow service 131. Although three clients are shown (clients 101, 103, and 105), many more additional clients can exist and access workflow service 131. Similarly, data sources 151 can include fewer or more data sources, and the included data sources may be located at different network locations. In some embodiments, components not shown in FIG. 1 may also exist.

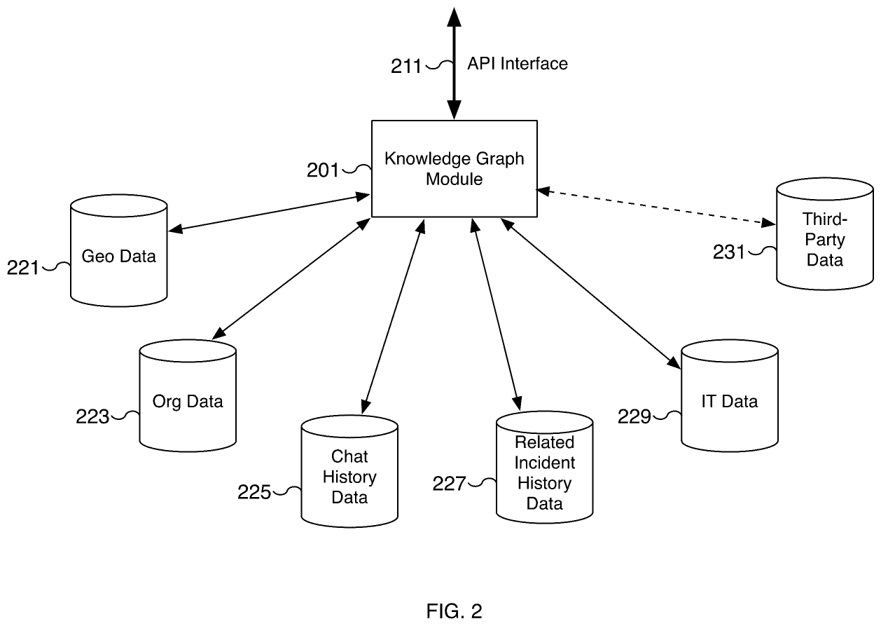

FIG. 2 is a block diagram illustrating an embodiment of a knowledge graph module for performing context-based digital workflows. In the example shown, knowledge graph module 201 is accessed via application programming interface (API) 211. Knowledge graph module 201 is configured with multiple data sources including geo data source 221, organization data source 223, chat history data source 225, related incident history data source 227, information technology (IT) data source 229, and third-party data source 231. In some embodiments, knowledge graph module 201 is knowledge graph module 141 of FIG. 1 and the data sources of FIG. 2 correspond to data sources 151 of FIG. 1. In some embodiments, digital workflows implemented by workflow service 131 of FIG. 1 access knowledge graph module 201 for resolving user queries using context-based data.

In some embodiments, knowledge graph module 201 is a knowledge graph service that allows a client to retrieve data organized in a knowledge graph. For example, knowledge graph module 201 is configured with multiple data stores and identifies relationships and associations between the data of the different data sources. For example, knowledge graph module 201 can merge related user data by an entity type, such as by employee, and make the organized data available as a service. The organized data spans the multiple different data sources and allows an external client to query a single source for all related data, such as data concerning a user or employee, that is available across the different configured data sources. In some embodiments, knowledge graph module 201 organizes the data by entities (such as by user, employee, work group, organizational group, etc.), relationships between entities, and properties that describe each entity. In various embodiments, knowledge graph module 201 provides context-based information in response to a knowledge graph API request via application programming interface (API) 211.

In some embodiments, application programming interface (API) 211 is used to access knowledge graph module 201 including to retrieve knowledge graph data organized by users. For example, API interface 211 can be accessed via a network such as network 121 of FIG. 1 to allow external clients to retrieve knowledge graph data from knowledge graph module 201. In some embodiments, API interface 211 can include a user identifier to retrieve knowledge graph data for the specified user, or another identifier such as an entity identifier corresponding to an organization, location, group, or another entity category. In some embodiments, API interface 211 can allow data to be retrieved from knowledge graph module 201 by specifying entities, relationships, and/or properties corresponding to entities.

In some embodiments, the data sources configured for knowledge graph module 201 include different data sources that typically may not interface with one another. Additionally, the data sources can include related and duplicative information and can include information based on a particular entity. For example, geo data source 221 can include geo-locational information for employees or for another entity type. As another example, organization data source 223 can include organizational data for different employees such as the manager, direct reports, and assigned organization for each employee. In some embodiments, chat history data source 225 can include at least a subset of past chat messages for each employee, related incident history data source 227 can include incident history for each employee, and information technology (IT) data source 229 can include IT information such as what devices and software are assigned to each employee. In various embodiments, one or more different third-party data sources such as third-party data source 231 can exist. Third-party data sources can correspond to external services such as a human resources service, a health plan service, an insurance service, and different financial services, etc. In some embodiments, a third-party data source such as third-party data source 231 is accessed via a third-party application programming interface (API).

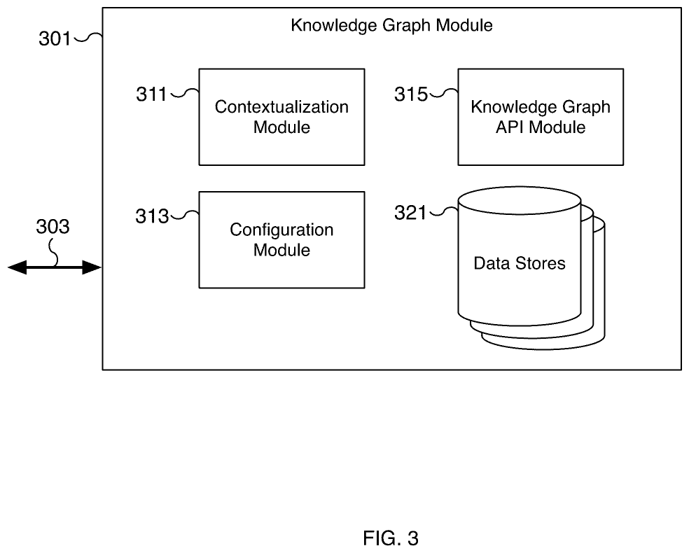

FIG. 3 is a block diagram illustrating an embodiment of a knowledge graph module for performing context-based digital workflows. In the example shown, components of knowledge graph module 301 include network interface 303, contextualization module 311, configuration module 313, knowledge graph application programming interface (API) module 315, and data stores 321. In some embodiments, knowledge graph module 301 is knowledge graph module 141 of FIG. 1 and/or knowledge graph module 201 of FIG. 2. In some embodiments, digital workflows implemented by workflow service 131 of FIG. 1 access knowledge graph module 301 for resolving user queries using context-based data.

In some embodiments, network interface 303 corresponds to a computer network interface used to retrieve data from different data sources configured for knowledge graph module 301. Additionally, network interface 303 can be used for receiving and serving knowledge graph requests such as requests adhering to a knowledge graph application programming interface (API). In some embodiments, network interface 303 is accessed via a local network or an external network such as network 121 of FIG. 1.

In some embodiments, contextualization module 311 is a processing module for constructing a knowledge graph based on a particular entity. In some embodiments, the provided knowledge graph is used to contextualize an entity by organizing the available data that exists for the entity by various relationships and entity properties. For example, contextualization module 311 may be used to construct a knowledge graph based on an employee entity by merging different employee data including location, organization, chat history, incident history, IT, human resource, life insurance, and retirement account data for an employee. In some embodiments, once the different associated data is merged by contextualization module 311, the organized data can provide the appropriate context when resolving a user query.

In some embodiments, configuration module 313 is a module for configuring knowledge graph module 301 including for configuring data sources used for generating a knowledge graph. In some embodiments, configuration module 313 can be utilized by an administrator for configuring the scope and depth of the knowledge graph creation process and may include configuring the intervals used for updating a knowledge graph. For example, different data sources, such as the data sources of FIGS. 1 and 2, can be configured for knowledge graph module 301. In some embodiments, configuring knowledge graph module 301 can be used to help configure the relevant entities, relationships, and/or properties of entities utilized by knowledge graph module 301.

In some embodiments, knowledge graph application programming interface (API) module 315 implements a knowledge graph API used for receiving and serving knowledge graph requests. For example, knowledge graph API 315 can implement an API for accessing knowledge graph data by entity, relationship, and/or entity property. As one example, knowledge graph API 315 can be used to retrieve all user related information such as all user data organized as a user profile when a user identifier is specified. In some embodiments, knowledge graph application programming interface (API) module 315 implements API interface 211 of FIG. 2.

In some embodiments, data stores 321 correspond to one or more data stores used to store knowledge graph data including knowledge graph metadata. For example, determined data and/or determined data associations and relationships can be stored in data stores 321. In some embodiments, data stores 321 also store the retrieval status corresponding to the configured data sources used by knowledge graph module 301 such as the last time each data source was analyzed for new data. In various embodiments, data stores 321 may be one or more data store instances and may include local, remote, and/or distributed data stores.

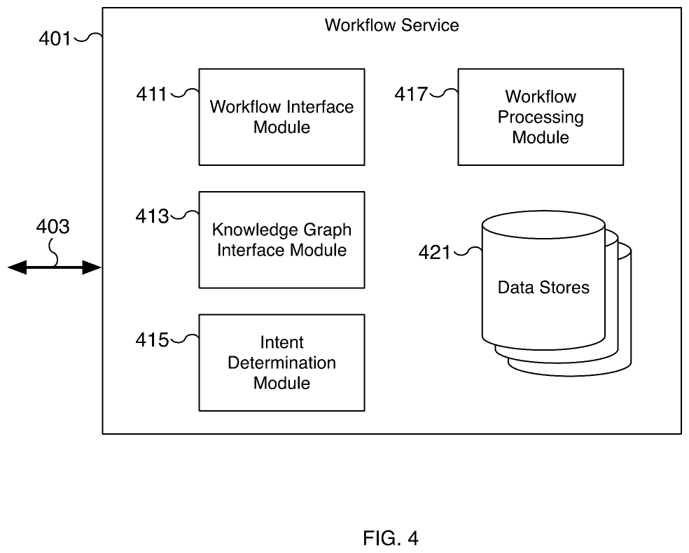

FIG. 4 is a block diagram illustrating an embodiment of a workflow service for performing context-based digital workflows. In the example shown, components of workflow service 401 include network interface 403, workflow interface module 411, knowledge graph interface module 413, intent determination module 415, workflow processing module 417, and data stores 421. In some embodiments, workflow service 401 is workflow service 131 of FIG. 1.

In some embodiments, network interface 403 corresponds to a computer network interface used to process user queries using a digital workflow. For example, a user query can be received via network interface 403 or workflow service 401, and a result or recommended resolution can be performed in response to the received query. Additionally, network interface 403 can be used for retrieving context-based knowledge such as data from a knowledge graph module and/or knowledge graph service. The retrieved knowledge graph data can be used for processing the appropriate digital workflow.

In some embodiments, workflow interface module 411 is a processing module for implementing an interface for servicing workflow service requests such as requests corresponding to user queries. For example, workflow interface module 411 can implement a workflow application programming interface (API). In some embodiments, workflow interface module 411 can also implement and/or leverage other interfaces for capturing user queries such as an interactive web dashboard or a chat agent. In various embodiments, workflow interface module 411 is used to capture a user query from a client and to provide a result to the client in response to the user query. Workflow interface module 411 can leverage the other modules of workflow service 401 for executing a digital workflow in response to a received user query.

In some embodiments, knowledge graph interface module 413 is a processing module for retrieving data from a knowledge graph. For example, knowledge graph interface module 413 can utilize a knowledge graph application programming interface (API) to retrieve user profile data for resolving a user query. In some embodiments, knowledge graph interface module 413 can retrieve data from a knowledge graph by specifying retrieval parameters related to an entity, entity relationships, and/or entity properties. In some embodiments, the knowledge graph data is retrieved from a knowledge graph module such as knowledge graph module 141 of FIG. 1, knowledge graph module 201 of FIG. 2, and/or knowledge graph module 301 of FIG. 3, and the knowledge graph API utilized by knowledge graph interface module 413 corresponds to API interface 211 of FIG. 2.

In some embodiments, intent determination module 415 is a processing module for determining the intent (or intents) behind a user query. For example, the user query can be analyzed to determine an intent that is matched to a corresponding digital workflow for resolving the user query. In various embodiments, the user query can include multiple intents and correspondingly map to multiple different workflows. When a user query is mapped to multiple workflows, a single parent workflow can be utilized to process all of the mapped workflows as sub-workflows. Alternatively, each of the mapped workflows can be processed independently. In some embodiments, intent determination module 415 can determine multiple intents and the dependencies between the determined intents. For example, when a second intent depends on a first intent, the processing of a workflow for the second intent may require the completion of the workflow associated with a first intent.

In some embodiments, intent determination module 415 determines the intent by performing an analysis on the user query. Additional context-based data such as data retrieved from a knowledge graph using knowledge graph interface module 413 or supplemental or historical data retrieved from associated data stores 421 can be used to determine the appropriate intents. In some embodiments, the intent is determined by syntactically analyzing the user query and related context data. In some embodiments, the intent can be determined by applying a machine learning model such as a large language model trained to analyze the user query and related context-based data. The intents and corresponding workflows are typically selected from preconfigured workflows. For example, the intents and corresponding workflows can be configured using a workflow designer process. In various embodiments, as part of the workflow configuration and design process, a workflow designer can specify specific keywords, filters, and/or triggers used to identify a particular intent based on the user query and related context-based data.

In some embodiments, the determination of an appropriate intent can be an iterative process and the determined intents for a user query can be refined even after an initial intent is determined. For example, as part of a refinement process, the user query can be augmented with additional data such as with knowledge graph and supplemental/historical data. For example, an initial intent is determined which initiates a digital workflow or pre-workflow process. The digital workflow or pre-workflow process can retrieve relevant knowledge graph and/or supplemental/historical data based on an initial determined intent. Using the retrieved context-based data, the appropriate intent(s) can be refined including by identifying additional or alternative intents and their corresponding digital workflows. In various embodiments, the selected workflows are processed using workflow processing module 417.

In some embodiments, workflow processing module 417 is a processing module for performing a digital workflow. For example, a configured workflow is performed by performing the steps assigned to the digital workflow. In some embodiments, the steps can include interactive steps such as prompts requiring a user response. The steps can be performed synchronously or asynchronously. In some embodiments, workflow processing module 417 can perform multiple workflows in response to a single user query and the workflows can be performed serially and/or in parallel, as appropriate. In various embodiments, workflow processing module 417 can determine one or more recommended resolutions and resolve a user query by performing the appropriate resolution(s).

In some embodiments, data stores 421 correspond to one or more data stores used to store workflow data including workflow configuration data and supplemental data for resolving workflows. For example, data stores 421 can store configured workflow steps, associated keywords and triggers, and workflow parameters and properties, among other workflow data. Data stores 421 may also store supplemental data used to resolve a workflow including historical data. For example, data stores 421 can store historical data used to resolve user queries such as incident solutions that have been successfully applied for other users. In various embodiments, data stores 421 may be one or more data store instances and may include local, remote, and/or distributed data stores.

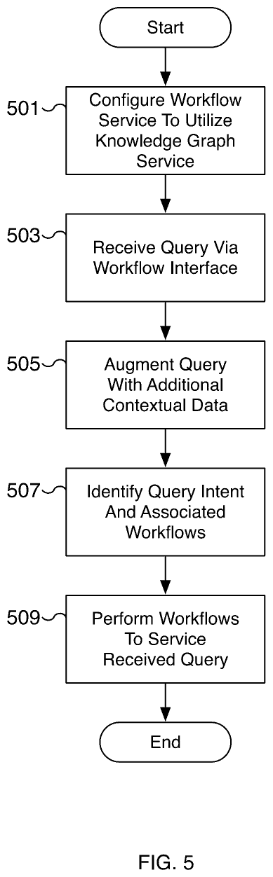

FIG. 5 is a flow chart illustrating an embodiment of a process for performing a context-based workflow processing. For example, using the process of FIG. 5, a user query is augmented with context-based data retrieved from a knowledge graph. The augmented user query can then be resolved by performing the appropriate digital workflow. In some embodiments, the process of FIG. 5 is performed by a workflow service such as by workflow service 131 of FIG. 1 and/or workflow service 401 of FIG. 4. In some embodiments, the knowledge graph data is retrieved from a knowledge graph module such as knowledge graph module 141 of FIG. 1, knowledge graph module 201 of FIG. 2, and/or knowledge graph module 301 of FIG. 3.

At 501, a workflow service is configured to utilize a knowledge graph service. For example, a knowledge graph service is first configured with multiple different data sources and used to generate a knowledge graph based on relationships identified across the different data sources. The workflow service is then configured to query the knowledge graph service. In various embodiments, configuration of the workflow service requires access to a single knowledge graph service whereas configuration of the knowledge graph service requires access to multiple different data sources.

At 503, a query is received via a workflow interface. For example, user chat message is received via a chat agent workflow interface and used to generated a user query. In some embodiments, the query can correspond to one or more chat messages captured via a chat agent. Example chat messages include: “My VPN is down,” “What is my PTO balance,” and “Why is my laptop slow.” In various embodiments, a chat message can be used to create a user query such as by adding additional query parameters. Additional parameters associated with the chat message can include a user identifier, a username, the source of the user message, the location of the user, etc. Other examples of a workflow interface include a web application dashboard, a command line interface, a voice assistant, etc. In some embodiments, the workflow interface corresponds to a workflow application programming interface (API).

At 505, the query is augmented with additional contextual data. For example, the user query is augmented with knowledge graph data and supplemental data such as historical or other supplemental data. In some embodiments, the knowledge graph data is retrieved from the knowledge graph service configured at 501. For example, a knowledge graph constructed to provide context for a user that merges user data across different data sources can be retrieved to provide additional context for the query. For supplemental context data, including historical data, the context data can include data related to the user query but not indexed by the user, such as related incidents experienced by other users and the solutions used to address the related incidents.

At 507, the query intent and associated workflows are identified. For example, an intent of the query is identified. In some embodiments, the intent is identified by analyzing the user query (with or without the additional contextual data) and based on the identified intent, additional contextual data is retrieved. With the retrieved context-based data, the intent can be further refined, if necessary, for example, by identifying a more narrow (or broader) intent and/or by identifying additional intends. Once an intent has been identified, the corresponding digital workflow used to process the intent can be identified. In some embodiments, multiple workflows can be identified for execution to resolve a single query.

At 509, workflows are performed to service the received query. For example, the workflows identified at 507 are performed using the contextual data retrieved at 505. In some embodiments, the workflows are performed in series, in parallel, and/or as a combination. For example, the identified workflows can include dependencies that require one to be performed and completed before another can start. The identified workflows can also be performed synchronously or asynchronously or as a mix of synchronously and asynchronously steps. In various embodiments, the recommended resolutions for the query are achieved by performing the identified workflows. In some embodiments, a response to the query received at 503 is provided. For example, one or more chat message responses can be provided in response to a query received based on a user chat message.

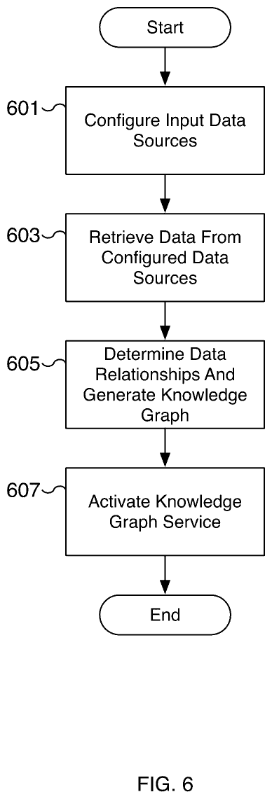

FIG. 6 is a flow chart illustrating an embodiment of a process for providing a knowledge graph service for performing context-based workflow processing. For example, using the process of FIG. 6, a knowledge graph service is configured that can be used by a client, such as a workflow service, to retrieve knowledge graph information. For example, the configured knowledge graph service can aggregate and organize data from multiple different data sources by identifying associations and relationships among the data of the configured data sources. The organized knowledge graph data can be used as contextual data for performing digital workflows. For example, the knowledge graph service can merge user data spread across different data sources and provide the organized user data as a user data profile for resolving a user-based query. User geo-location, organization, chat history, incident history, information technology (IT), human resources, insurance, and financial data, among other types of user data can be aggregated and organized into a knowledge graph user profile. When provided to a workflow service, the user profile can be used to perform a digital workflow without requiring additional tedious and error-prone user data gathering steps. In some embodiments, the process of FIG. 6 is performed at 501 of FIG. 1 by a knowledge graph service. In some embodiments, a knowledge graph service corresponds to knowledge graph module 141 of FIG. 1, knowledge graph module 201 of FIG. 2, and/or knowledge graph module 301 of FIG. 3. In some embodiments, the process of FIG. 6 is routinely performed, for example, to update the knowledge graph when the underlying data has changed.

At 601, input data sources are configured. For example, multiple input data sources are configured for a knowledge graph service. The data sources can include internal and external (or third-party) data sources including data files and database tables. In various embodiments, the data sources may be incompatible with one another, may be dispersed and/or disparate, and may include overlapping or duplicative data. The data sources configured are used to provide input data for the knowledge graph service. Example data sources include different data sources for geo-location data, organization data, chat history data, incident history data, information technology (IT) data, human resources data, insurance data, and financial data, among others.

At 603, data is retrieved from the configured data sources. For example, data is collected from the input data sources configured at 601. In some embodiments, the data retrieval process includes identifying the relevant data for retrieval and their corresponding data types. In various embodiments, the data sources may require different retrieval techniques such as different transfer or query protocols. For example, based on the configuration performed at 601, the data from the different data sources can be retrieved according to the configuration provided.

At 605, data relationships are determined and a knowledge graph is generated. For example, a contextual data set is created from the data retrieved at 603. In various embodiments, the data is analyzed for data relationships and associations. For example, a user's office location from a first data source, organizational position from a second data source, and assigned information technology (IT) assets from a third data source can be associated based on their relationship to the user. In some embodiments, the collected data is analyzed by contextualizing the data according to determined entities, their relationships, and their properties to create the knowledge graph. In various embodiments, the contextualized data is stored in one or more data stores of the knowledge graph service.

At 607, the knowledge graph service is activated. For example, the knowledge graph data generated at 605 is made available for retrieval via an interface such as an application programming interface (API). In some embodiments, a knowledge graph API allows for the knowledge graph to be queried by entity, entity relationship, and/or entity properties. For example, a client such as a workflow service can query a knowledge graph service for a knowledge graph user profile of a particular user. Once activated, a knowledge graph service can deliver a formatted data set in response to the knowledge graph query.

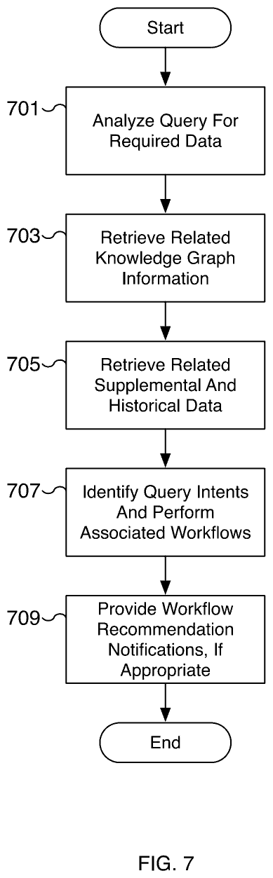

FIG. 7 is a flow chart illustrating an embodiment of a process for resolving a user query using context-based data and a digital workflow. For example, using the process of FIG. 7, a user query is analyzed and augmented with context-based data including knowledge graph and supplemental and historical data. An intent of the user query is determined, and a corresponding workflow is performed to resolve the user query. In some embodiments, multiple workflows are performed such as when the user query has multiple underlying intents. In some embodiments, the process of FIG. 7 is performed by a workflow service such as by workflow service 131 of FIG. 1 and/or workflow service 401 of FIG. 4 at 505, 507, and/or 509 of FIG. 5.

At 701, a query is analyzed for required data. For example, a query is analyzed to determine the additional contextual data required to resolve the query. In some embodiments, a query is analyzed to determine whether the query is associated with a particular entity such as a user. In some embodiments, once a particular user is determined to be associated with the query, a knowledge graph organizing the user data can be identified as additional required data. In some embodiments, the user is determined based on a user identifier, a username, an employee number, or by another identifier. In some embodiments, the required data is determined based on a relationship or property associated with the identifier. The determined required data can be used to supplement the context of the query and to provide a more complete perspective of the query in order to identify previously undetectable issues.

At 703, related knowledge graph data is retrieved. For example, a knowledge graph module or knowledge graph service is accessed to retrieve the related knowledge graph data. In some embodiments, the knowledge graph is queried to access the data required for expanding the context available for resolving the query. For example, a knowledge graph organizing a user profile for the user can be retrieved. The retrieved knowledge graph data can include all data related to the user that can be found from the configured data sources for the knowledge graph service.

At 705, related supplemental and historical data are retrieved. For example, supplemental data associated with the query can be retrieved. In some embodiments, the supplemental data includes historical data such as past incidents and their determined solutions. The supplemental data may be stored external to the knowledge graph and is used to supplement the context where the knowledge graph data may be insufficient. For example, the supplemental/historical data can include data not organized by the user of the query, such as data for incidents experienced by other users but that occurred in a time frame relevant to the query.

At 707, query intents are identified and associated workflows are performed. For example, the query is analyzed to identify one or more intents of the query. In some embodiments, the analysis is performed using the expanded context provided by the knowledge graph data and the supplemental and historical data retrieved at 703 and 705, respectively. Using the expanding context, the intent (or intents) of the user query can be identified. In some embodiments, the intent is determined by applying a trained machine learning model such as a large language model. In some embodiments, the intent is determined by performing a syntactical analysis of the user query and related data including by analyzing the message for configured keywords.

In various embodiments, once an intent has been identified, its corresponding associated workflow can be selected and performed. For example, for each intent, a digital workflow is configured to resolve the intent. When multiple intents are identified, multiple workflows can be performed to provide multiple different resolutions for the query. For example, a slow laptop can be addressed by a first workflow that provides the appropriate knowledge-based article, a second workflow that attempts to upgrade the user's laptop, and a third workflow that updates the software on the user's existing laptop. In various embodiments, the context-based data used to augment the user query can be used to help complete the identified workflows. For example, user information technology (IT) data can be used to identify out-of-date applications installed on the user's laptop and to determine whether the user is eligible for a laptop refresh. Additionally, organizational data can be used to notify the user's manager for approval of a new laptop, and office location data can be used to prepopulate a delivery address for the user for shipment of a new laptop.

At 709, notifications of workflow recommendations are provided, if appropriate. For example, when appropriate, a response to the query can include notifications of the recommendations used to resolve the query by the workflows performed at 707. In various embodiments, the recommendations can include chat messages notifying the user of the appropriate actions taken, such as a chat message that provides a link to a recommended knowledge base article. As another example, a notification can include a response to the user notifying the user that a new laptop can be issued to resolve the user's slow laptop issue. In various embodiments, each workflow can include a corresponding recommended resolution, and the recommended resolution may require notifications to the user. In some embodiments, the notification of recommendations process is an interactive one and requires prompting the user for additional information, such as permission to perform an action with a follow up result.

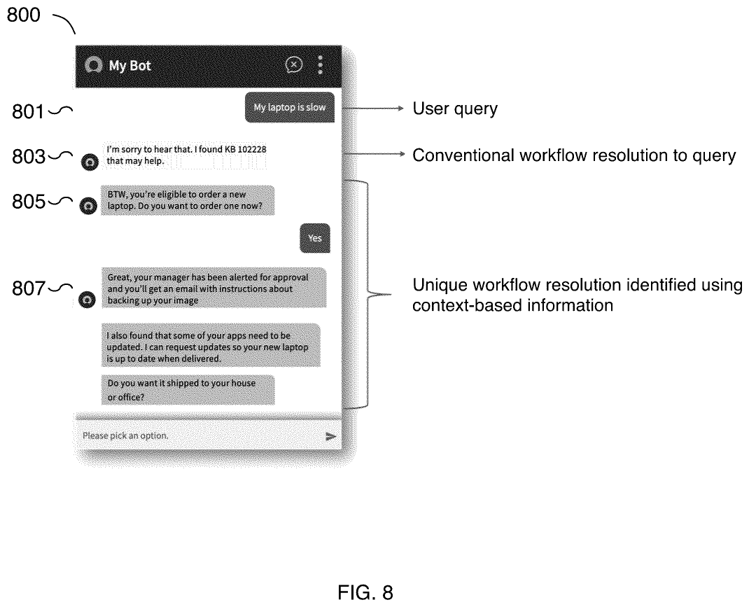

FIG. 8 is a diagram illustrating an embodiment of a user interface displaying the results of performing a context-based digital workflow. In the example shown, chat window 800 is a chat bot user interface and displays chat messages between a user and a chat agent. Chat window 800 is an example of a user interface for capturing user queries for a workflow service. In some embodiments, chat window 800 corresponds to a workflow interface implemented as part of the workflow service. For example, a user of a client such as client 101, 103, or 105 of FIG. 1 can initiate a chat dialog with a chat workflow interface of workflow service 131 of FIG. 1. In some embodiments, the chat interface is implemented by workflow interface module 411 of workflow service 401 of FIG. 4. In some embodiments, the context-based digital workflow interaction shown in chat window 800 is implemented by the processes of FIGS. 5-7.

As shown in FIG. 8, chat window 800 includes user chat message 801 (“My laptop is slow”) that is used to create a user query. The user query corresponding to user chat message 801 is received and processed by a workflow service and augmented with contextual or context-based data. In some embodiments, the received user query can include additional qualifiers in addition to user chat message 801 such as a username, user identifier, the time of the query, the source location of the query, etc. The augmented context-based data is retrieved by the workflow service and can include a knowledge graph for the user and related supplemental or historical information. For example, using the processes of FIGS. 5-7, the user query is augmented with knowledge graph data of the user and/or supplemental and historical data related to laptop performance issues. The workflow server analyzes the augmented user query to determine one or more intents related to resolving the user's laptop issue. The workflow service identifies two corresponding digital workflows, one to present a relevant knowledge base article and another to refresh the user's laptop with a new laptop in the event the laptop qualifies for a refresh.

In the example shown, chat window 800 displays two workflow resolutions to user chat message 801. Chat response message 803 corresponds to the first digital workflow, which directs the user to the relevant knowledge base article as a first resolution. Chat response messages 805 and 807 correspond to a second resolution and proceed to navigate the user through a second digital workflow to determine whether the user would like to perform a laptop refresh by ordering a new laptop. The second workflow has already determined (as part of the workflow) that the user qualifies for a new laptop based on the retrieved knowledge graph data that includes the user's information technology configuration. Once the user responds with a “Yes” to agree to ordering a new laptop, the second digital workflow then proceeds with additional steps of the laptop ordering process including by contacting the user's manager for approval, identifying software that requires updates, and prompting the user for a shipping location. Using context-based information from the knowledge graph, the second digital workflow is provided with the user's manager's contact information, the user's installed software applications, and the user's default shipping address without prompting the user.

As shown by the labels in FIG. 8, the first digital workflow corresponding to chat response message 803 is a conventional workflow resolution that can be initiated without augmented context-based information such as without the knowledge graph of the user. The second digital workflow corresponding to chat response messages 805 and 807 is a unique workflow recommendation based on a second digital workflow selected using the augmented context-based information. The second workflow and its recommended resolution are only possible due to the additional context-based information such as the user-related context information provided by the knowledge graph. Without the augmented context-based information, completing the workflow recommendation shown in FIG. 8 would require many more chat interactions to gather the required additional user data, such as the user's laptop refresh date, the user's manager and manager contact information, the user's shipping address, etc. Using the disclosed invention described in FIGS. 1-7, the different workflows can be identified and the corresponding workflow resolutions can be performed in response to only a single user message (user chat message 801).

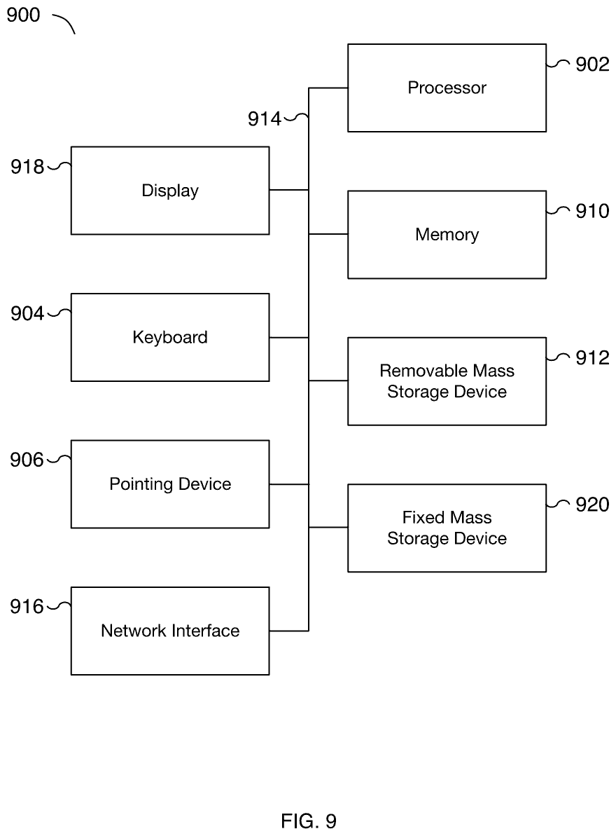

FIG. 9 is a functional diagram illustrating a programmed computer system for performing context-based digital workflows. As will be apparent, other computer system architectures and configurations can be utilized for performing context-based digital workflows. Examples of computer system 900 include clients 101, 103, and 105 of FIG. 1 and one or more computers of workflow service 131 of FIG. 1, knowledge graph module 141 of FIG. 1, knowledge graph module 201 of FIG. 2, knowledge graph module 301 of FIG. 3, and workflow service 401 of FIG. 4. Additional examples of computer system 900 can further include the computer systems associated with the data sources shown in FIGS. 1-4. Computer system 900, which includes various subsystems as described below, includes at least one microprocessor subsystem (also referred to as a processor or a central processing unit (CPU)) 902. For example, processor 902 can be implemented by a single-chip processor or by multiple processors. In some embodiments, processor 902 is a general purpose digital processor that controls the operation of the computer system 900. Using instructions retrieved from memory 910, the processor 902 controls the reception and manipulation of input data, and the output and display of data on output devices (e.g., display 918). In various embodiments, one or more instances of computer system 900 can be used to implement at least portions of the processes of FIGS. 5-7 and the functionality associated with the diagrams of FIGS. 1-4 and/or 8.

Processor 902 is coupled bi-directionally with memory 910, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 902. Also as is well known in the art, primary storage typically includes basic operating instructions, program code, data and objects used by the processor 902 to perform its functions (e.g., programmed instructions). For example, memory 910 can include any suitable computer-readable storage media, described below, depending on whether, for example, data access needs to be bi-directional or unidirectional. For example, processor 902 can also directly and very rapidly retrieve and store frequently needed data in a cache memory (not shown).

A removable mass storage device 912 provides additional data storage capacity for the computer system 900, and is coupled either bi-directionally (read/write) or unidirectionally (read only) to processor 902. For example, storage 912 can also include computer-readable media such as magnetic tape, flash memory, PC-CARDS, portable mass storage devices, holographic storage devices, and other storage devices. A fixed mass storage 920 can also, for example, provide additional data storage capacity. The most common example of mass storage 920 is a hard disk drive. Mass storages 912, 920 generally store additional programming instructions, data, and the like that typically are not in active use by the processor 902. It will be appreciated that the information retained within mass storages 912 and 920 can be incorporated, if needed, in standard fashion as part of memory 910 (e.g., RAM) as virtual memory.

In addition to providing processor 902 access to storage subsystems, bus 914 can also be used to provide access to other subsystems and devices. As shown, these can include a display monitor 918, a network interface 916, a keyboard 904, and a pointing device 906, as well as an auxiliary input/output device interface, a sound card, speakers, and other subsystems as needed. For example, the pointing device 906 can be a mouse, stylus, track ball, or tablet, and is useful for interacting with a graphical user interface.

The network interface 916 allows processor 902 to be coupled to another computer, computer network, or telecommunications network using a network connection as shown. For example, through the network interface 916, the processor 902 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 902 can be used to connect the computer system 900 to an external network and transfer data according to standard protocols. For example, various process embodiments disclosed herein can be executed on processor 902, or can be performed across a network such as the Internet, intranet networks, or local area networks, in conjunction with a remote processor that shares a portion of the processing. Additional mass storage devices (not shown) can also be connected to processor 902 through network interface 916.

An auxiliary I/O device interface (not shown) can be used in conjunction with computer system 900. The auxiliary I/O device interface can include general and customized interfaces that allow the processor 902 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 9 is but an example of a computer system suitable for use with the various embodiments disclosed herein. Other computer systems suitable for such use can include additional or fewer subsystems. In addition, bus 914 is illustrative of any interconnection scheme serving to link the subsystems. Other computer architectures having different configurations of subsystems can also be utilized.

One aspect of the disclosure includes a method for receiving data from a plurality of data sources; generating a knowledge graph using the received data to discover user relationships between elements of the data from the plurality of data sources; receiving, from a user, a query associated with a workflow; using an application programming interface, querying the knowledge graph for data associated with the user and the query; and determining, by analyzing a result of the query of the knowledge graph, a recommendation associated with the workflow. Implementations of the disclosure may include one or more of the following optional features including wherein the plurality of data sources includes at least one of a geo-location data store, a company data store, an organization data store, a chat history data store, a related incident history data store, or an information technology (IT) data store; wherein the plurality of data sources includes an external data source accessed via a third-party application programming interface; wherein the query is associated with a chat message received via a chat interface; wherein the query includes an identifier of the user and is based on a chat message; and wherein analyzing the result of the query of the knowledge graph includes determining an intent associated with the query; wherein the workflow associated with the query is selected from a plurality of workflows based on the determined intent; retrieving supplemental data associated with the user and the query, wherein the analysis is performed using the supplemental data; wherein the supplemental data includes historical data; and/or wherein the supplemental data includes data collected from a second user different from the user.

Another aspect of the disclosure provides a system with one or more processors and a memory coupled to the one or more processors, wherein the memory is configured to provide the one or more processors with instructions which when executed cause the one or more processors to: receive data from a plurality of data sources; generate a knowledge graph using the received data to discover user relationships between elements of the data from the plurality of data sources; receive, from a user, a query associated with a workflow; using an application programming interface, query the knowledge graph for data associated with the user and the query; and determine, by analyzing a result of the query of the knowledge graph, a recommendation associated with the workflow. This aspect may include one or more of the following optional features including wherein the plurality of data sources includes at least one of a geo-location data store, a company data store, an organization data store, a chat history data store, a related incident history data store, or an information technology (IT) data store; wherein the plurality of data sources includes an external data source accessed via a third-party application programming interface; wherein the query is associated with a chat message received via a chat interface; wherein the query includes an identifier of the user and is based on a chat message; and analyzing the result of the query of the knowledge graph includes to determine an intent associated with the query; wherein the workflow associated with the query is selected from a plurality of workflows based on the determined intent; retrieving supplemental data associated with the user and the query, wherein the analysis is performed using the supplemental data; wherein the supplemental data includes historical data; and/or wherein the supplemental data includes data collected from a second user different from the user.

In various embodiments, the disclosed invention may also be implemented as a computer program product, the computer program product being embodied in a non-transitory computer readable storage medium and comprising computer instructions for: receiving data from a plurality of data sources; generating a knowledge graph using the received data to discover user relationships between elements of the data from the plurality of data sources; receiving, from a user, a query associated with a workflow; using an application programming interface, querying the knowledge graph for data associated with the user and the query; and determining, by analyzing a result of the query of the knowledge graph, a recommendation associated with the workflow. The details of one or more implementations of the disclosure are set forth in the accompanying drawings and description. Other aspects, features, and advantages will be apparent from the description and drawings, and from the claims.

Although the foregoing embodiments have been described in some detail for purposes of clarity of understanding, the invention is not limited to the details provided. There are many alternative ways of implementing the invention. The disclosed embodiments are illustrative and not restrictive.

1. A method comprising:
receiving data from a plurality of data sources;
generating a knowledge graph using the received data to discover user relationships between elements of the data from the plurality of data sources;
receiving, from a user, a query associated with a workflow;
using an application programming interface, querying the knowledge graph for data associated with the user and the query; and
determining, by analyzing a result of the query of the knowledge graph, a recommendation associated with the workflow.

2. The method of claim 1, wherein the plurality of data sources includes at least one of a geo-location data store, a company data store, an organization data store, a chat history data store, a related incident history data store, or an information technology (IT) data store.

3. The method of claim 2, wherein the plurality of data sources includes an external data source accessed via a third-party application programming interface.

4. The method of claim 1, wherein the query is associated with a chat message received via a chat interface.

5. The method of claim 1, wherein the query includes an identifier of the user and is based on a chat message.

6. The method of claim 1, wherein analyzing the result of the query of the knowledge graph includes determining an intent associated with the query.

7. The method of claim 6, wherein the workflow associated with the query is selected from a plurality of workflows based on the determined intent.

8. The method of claim 1, further comprising retrieving supplemental data associated with the user and the query, and wherein the analysis is performed using the supplemental data.

9. The method of claim 8, wherein the supplemental data includes historical data.

10. The method of claim 9, wherein the supplemental data includes data collected from a second user different from the user.

11. A system, comprising:
one or more processors; and
a memory coupled to the one or more processors, wherein the memory is configured to provide the one or more processors with instructions which when executed cause the one or more processors to:
receive data from a plurality of data sources;
generate a knowledge graph using the received data to discover user relationships between elements of the data from the plurality of data sources;
receive, from a user, a query associated with a workflow;
using an application programming interface, query the knowledge graph for data associated with the user and the query; and
determine, by analyzing a result of the query of the knowledge graph, a recommendation associated with the workflow.

12. The system of claim 11, wherein the plurality of data sources includes at least one of a geo-location data store, a company data store, an organization data store, a chat history data store, a related incident history data store, or an information technology (IT) data store.

13. The system of claim 12, wherein the plurality of data sources includes an external data source accessed via a third-party application programming interface.

14. The system of claim 11, wherein the query is associated with a chat message received via a chat interface.

15. The system of claim 11, wherein the query includes an identifier of the user and is based on a chat message.

16. The system of claim 11, wherein analyzing the result of the query of the knowledge graph includes to determine an intent associated with the query.

17. The system of claim 11, wherein the memory is further configured to provide the one or more processors with instructions which when executed cause the one or more processors to: retrieve supplemental data associated with the user and the query, and wherein the analysis is performed using the supplemental data.

18. The system of claim 17, wherein the supplemental data includes historical data.

19. The system of claim 18, wherein the supplemental data includes data collected from a second user different from the user.

20. A computer program product, the computer program product being embodied in a non-transitory computer readable storage medium and comprising computer instructions for:
receiving data from a plurality of data sources;
generating a knowledge graph using the received data to discover user relationships between elements of the data from the plurality of data sources;
receiving, from a user, a query associated with a workflow;
using an application programming interface, querying the knowledge graph for data associated with the user and the query; and
determining, by analyzing a result of the query of the knowledge graph, a recommendation associated with the workflow.
